(19) United States
(12) Patent Application Publication
(10) Pub. No.: US 2022/0006126 A1
(43) Pub. Date: Jan. 6, 2022

(54) SOLID-STATE BATTERY

(71) Applicant: TOYOTA JIDOSHA KABUSHIKI KAISHA, Toyota-shi (JP)

(72) Inventors: Koji OKUDA, Nagoya-shi (JP); Yuki MATSUSHITA, Nagoya-shi (JP)

(21) Appl. No.: 17/364,860

(22) Filed: Jun. 30, 2021

(30) Foreign Application Priority Data
Jul. 3, 2020 (JP) 2020-115556

(51) Int. Cl. H01M 10/0585; H01M 50/124

(52) U.S. Cl. CPC H01M 10/0585; H01M 50/124

(57) ABSTRACT

A solid-state battery includes an electrode assembly including a plurality of unit stacked bodies arranged in a stacking direction, and a laminate film that seals the electrode assembly. Each of the plurality of unit stacked bodies includes a positive electrode layer, a negative electrode layer, a solid electrolyte layer, and an insulating layer. A thickness of the insulating layer of the unit stacked body disposed on one end surface side of the electrode assembly is greater than a thickness of the insulating layer of the unit stacked body provided on the central side of the electrode assembly.

This nonprovisional application is based on Japanese Patent Application No. 2020-115556 filed on Jul. 3, 2020 with the Japan Patent Office, the entire contents of which are hereby incorporated by reference.

### BACKGROUND

### Field

The present disclosure relates to a solid-state battery.

### Description of the Background Art

In recent years, attention has been focused on a solid-state battery. The solid-state battery includes an electrode assembly including a solid electrolyte layer, and a laminate film that houses the electrode assembly. For example, a solid-state battery described in Japanese Patent Laying-Open No. 2019-121558 includes an electrode assembly formed by a plurality of stacked unit electrode assemblies.

Each of the unit electrode assemblies includes a positive electrode collector plate, a positive electrode active material layer, a solid electrolyte layer, a negative electrode active material layer, a first negative electrode collector plate, and a second negative electrode collector plate. The first negative electrode collector plate is provided on an upper surface of the solid-state battery, and the second negative electrode collector plate is provided on a lower surface of the solid-state battery.

When the plurality of unit electrode assemblies are stacked, the unit electrode assemblies are stacked such that the first negative electrode collector plate of one unit electrode assembly is in contact with the second negative electrode collector plate of the other unit electrode assembly.

A process of manufacturing a solid-state battery includes an electrode assembly forming step and a sealing step. In the electrode assembly forming step, negative electrode active material layers are, for example, formed on an upper surface and a lower surface of a negative electrode collector plate. A solid electrolyte layer is formed on an upper surface of the negative electrode active material layer on the upper surface side, and a solid electrolyte layer is also formed on a lower surface of the negative electrode active material layer on the lower surface side.

A positive electrode active material layer is formed on an upper surface of the solid electrolyte layer on the upper surface side, and a positive electrode active material layer is also formed on a lower surface of the solid electrolyte layer on the lower surface side.

Then, an outer periphery of each of the positive electrode active material layers is removed by laser light and the like, in order to suppress a short circuit and the like in the positive electrode active material layers and the negative electrode active material layers. Then, the stacked body is cut into a prescribed length. A positive electrode collector plate is formed on an upper surface of the cut stacked body, to thereby obtain a unit stacked body. Then, the unit stacked bodies are stacked sequentially, to thereby obtain an electrode assembly.

In the sealing step, the electrode assembly is inserted into a laminate film and the air in the laminate film is suctioned. The solid-state battery is thus manufactured.

In the step of cutting the stacked body, a burr may occur in a cut portion. Let us assume the case of forming the electrode assembly in the presence of the burr.

When the air in the laminate film is suctioned in the sealing step, an inner surface of the laminate film comes into close contact with the electrode assembly. As a result, for example, the positive electrode collector plate comes into contact with the burr, which may result in a potential drop and the like.

### SUMMARY

The present disclosure has been made in light of the above-described problem, and an object of the present disclosure is to provide a solid-state battery in which the occurrence of a potential drop is suppressed, the solid-state battery including an electrode assembly and a laminate film that seals the electrode assembly.

A solid-state battery according to the present disclosure includes: an electrode assembly including a plurality of unit stacked bodies arranged in a stacking direction; and a laminate film that seals the electrode assembly. The electrode assembly includes a first end surface located on one end in the stacking direction, and a second end surface located on the other end in the stacking direction. Each of the plurality of unit stacked bodies includes: a first electrode layer including a first main surface and a second main surface; a first solid electrolyte layer formed on the first main surface; a second solid electrolyte layer formed on the second main surface; a second electrode layer and an insulating layer formed opposite to the first electrode layer relative to the first solid electrolyte layer; a collector plate formed opposite to the first solid electrolyte layer relative to the second electrode layer and the insulating layer; and a third electrode layer formed opposite to the first electrode layer relative to the second solid electrolyte layer.

The insulating layer is formed to cover an outer peripheral edge portion of the first solid electrolyte layer. The collector plate is provided on the second electrode layer and provided to cover the insulating layer. When N represents the number of the unit stacked bodies, and M represents an integer value obtained by rounding up all digits to the right of a decimal point of N/2×0.1, first unit stacked bodies refer to unit stacked bodies ranging from a unit stacked body located on the first end surface to at least an M-th unit stacked body, of the plurality of unit stacked bodies, and second unit stacked bodies refer to unit stacked bodies other than the first unit stacked bodies, of the plurality of unit stacked bodies. When the insulating layer provided in each of the first unit stacked bodies is defined as a first insulating layer and the insulating layer provided in each of the second unit stacked bodies is defined as a second insulating layer, a thickness of the first insulating layer is greater than a thickness of the second insulating layer.

In the above-described solid-state battery, a burr may be formed at the outer peripheral edge portion of the first solid electrolyte layer in the process of forming each unit stacked body. The unit stacked bodies each having such a burr may be stacked to thereby form the electrode assembly.

In the above-described solid-state battery, when a pressure is applied from the laminate film to the electrode assembly, a load is applied to a surface layer of the electrode assembly. On the other hand, the load is less likely to reach the central side of the electrode assembly.

In the above-described solid-state battery, the unit stacked bodies ranging from the unit stacked body located on the first end surface to at least the M-th unit stacked body correspond to the first unit stacked bodies, and thus, the insulating layer is thick. Therefore, even when each of the first unit stacked bodies has the burr, penetration of the burr through the insulating layer to come into contact with the collector plate can be suppressed.

On the other hand, the second unit stacked bodies each having the thin insulating layer are located at the center of the electrode assembly, and thus, the load is less likely to reach the second unit stacked bodies. Therefore, even when each of the second unit stacked bodies has the burr, penetration of the burr through the insulating layer is suppressed.

A thickness of a portion of the electrode assembly passing through the second electrode layer and the third electrode layer is greater, in the stacking direction, than a thickness of a portion of the electrode assembly passing through the insulating layer.

According to the above-described solid-state battery, a situation is suppressed in which the thickness of the portion of the electrode assembly where the insulating layer is located is greater, in the stacking direction, than the thickness of the portion of the electrode assembly where the second electrode layer is located. Therefore, concentration of a load on the portion where the insulating layer is located when a pressure is applied from the first end surface to the electrode assembly can be suppressed. As a result, even when each of the unit stacked bodies has the burr, the load at which the burr is pressed against the insulating layer can be kept small.

A burr is formed at the outer peripheral edge portion of each of the first unit stacked bodies, and the first insulating layer is disposed to cover the burr.

According to the above-described solid-state battery, the insulating layer makes it possible to suppress contact of the burr with the collector plate.

The thickness of the first insulating layer is greater than a height of the burr. According to the above-described solid-state battery, even when a load is applied to the first unit stacked bodies, penetration of the burr through the first insulating layer can be suppressed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view schematically showing a solid-state battery 1 according to the present embodiment.

FIG. 2 is a cross-sectional view showing a part of an electrode assembly 2.

FIG. 3 is a cross-sectional view schematically showing a unit stacked body 4A.

FIG. 4 is a cross-sectional view showing a unit stacked body 4B.

FIG. 5 is a cross-sectional view showing a configuration of a burr 40 and its surroundings.

FIG. 6 is a cross-sectional view showing a configuration of a burr 41 and its surroundings.

FIG. 7 is a manufacturing flow chart showing a step of forming unit stacked body 4A.

FIG. 8 is a cross-sectional view showing a step of preparing a negative electrode sheet 50.

FIG. 9 is a cross-sectional view showing a step of forming a sheet 53 on negative electrode sheet 50.

FIG. 10 is a cross-sectional view showing a step after the step shown in FIG. 9.

FIG. 11 shows a step of forming a positive electrode sheet 56 on a surface of each solid electrolyte layer 54.

FIG. 12 is a cross-sectional view showing a step after the step shown in FIG. 11.

FIG. 13 shows a step of removing a part of a positive electrode composite material layer 58.

FIG. 14 is a cross-sectional view showing a step of cutting a part of a stacked body shown in FIG. 13.

FIG. 15 is a cross-sectional view showing a step of bonding insulating layers 25, 26 and 27.

FIG. 16 is a cross-sectional view showing a step of disposing a positive electrode current collector 19.

FIG. 17 is a table showing the results of studies about solid-state batteries according to Examples 1 to 6 and solid-state batteries according to Comparative Examples 1 to 7.

FIG. 18 is a cross-sectional view showing a unit stacked body 4C.

FIG. 19 is a table showing the results of short circuit analysis about ten disassembled electrode assemblies of the solid-state battery according to Comparative Example 1 in which a voltage drop occurred.

### DESCRIPTION OF THE PREFERRED EMBODIMENTS

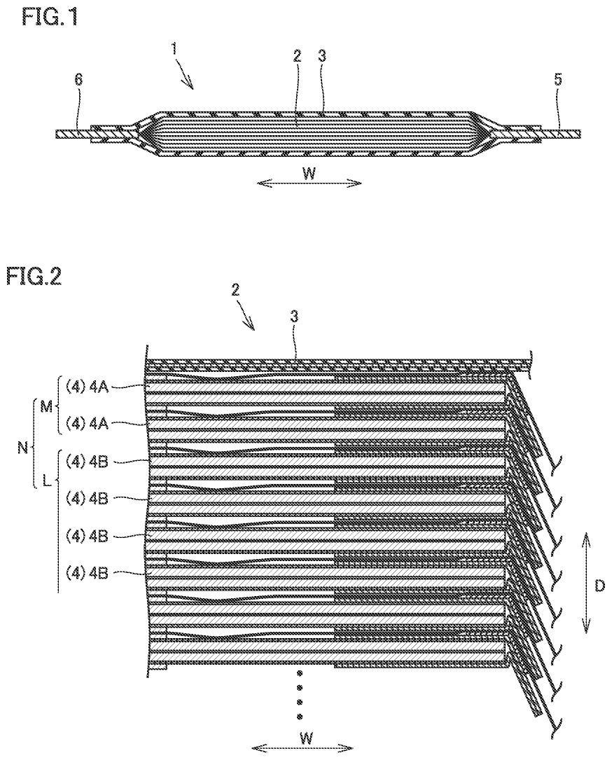

A solid-state battery 1 according to the present embodiment will be described with reference to FIGS. 1 to 19. The same or substantially the same components of the configurations shown in FIGS. 1 to 19 are denoted by the same reference characters, and redundant description will not be repeated.

FIG. 1 is a cross-sectional view schematically showing solid-state battery 1 according to the present embodiment. Solid-state battery 1 includes an electrode assembly 2, a laminate film 3, a positive electrode terminal 5, and a negative electrode terminal 6.

Electrode assembly 2 is housed in laminate film 3. Laminate film 3 has, for example, a three-layer structure. That is, laminate film 3 may include, for example, a first resin layer, a metal layer and a second resin layer. The metal layer is sandwiched between the first resin layer and the second resin layer. The metal layer may have a thickness of, for example, 10 μm to 100 μm. The metal layer may include, for example, aluminum (Al) or the like. Each of the first resin layer and the second resin layer may include, for example, at least one selected from the group consisting of polyethylene (PE), polyethylene terephthalate (PET) and polyamide (PA). Each of the first resin layer and the second resin layer may have a thickness of, for example, 10 μm to 100 μm. An air pressure in laminate film 3 is, for example, approximately 40 Pa.

Positive electrode terminal 5 is drawn out from inside to outside laminate film 3, and a plurality of positive electrode collector plates of electrode assembly 2 are connected to positive electrode terminal 5. Negative electrode terminal 6 is drawn out from inside to outside laminate film 3, and a plurality of negative electrode collector plates of electrode assembly 2 are connected to negative electrode terminal 6. Solid-state battery 1 is formed to be long in a width direction W. In width direction W, positive electrode terminal 5 is drawn out from one end side of solid-state battery 1, and negative electrode terminal 6 is drawn out from the other end side.

FIG. 2 is a cross-sectional view showing a part of electrode assembly 2. Electrode assembly 2 includes a plurality of unit stacked bodies 4 stacked in a stacking direction D. Stacking direction D corresponds to a vertical direction in the example shown in FIG. 1 and the like. The number of unit stacked bodies 4 is, for example, approximately five to one hundred. The number of unit stacked bodies 4 may be approximately twenty to fifty. The number of unit stacked bodies 4 may be, for example, approximately thirty.

The plurality of unit stacked bodies 4 include a unit stacked body (first unit stacked body) 4A and a unit stacked body (second unit stacked body) 4B. In the present embodiment, unit stacked body 4A is disposed on the one end (upper end) side of electrode assembly 2 in stacking direction D, and unit stacked body 4B is located on the central side of electrode assembly 2 in stacking direction D.

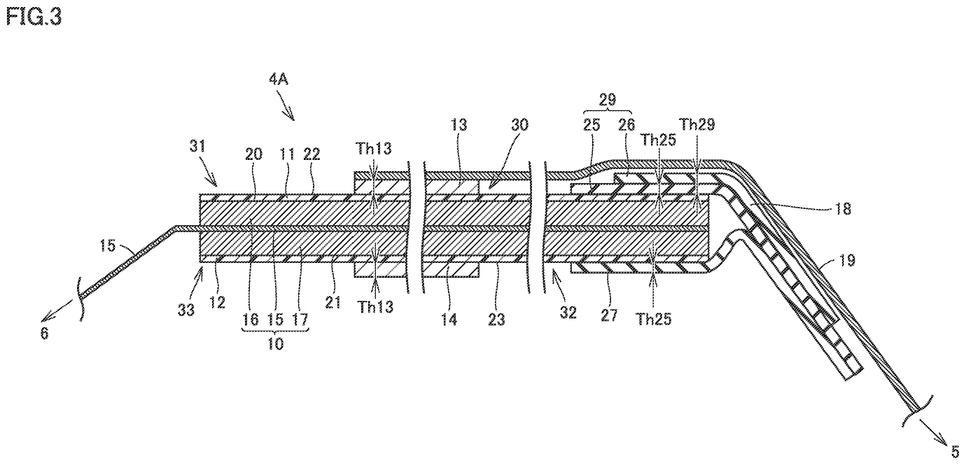

FIG. 3 is a cross-sectional view schematically showing unit stacked body 4A. Unit stacked body 4A includes a negative electrode layer (first electrode layer) 10, a solid electrolyte layer (first solid electrolyte layer) 11, a solid electrolyte layer (second solid electrolyte layer) 12, a positive electrode layer (second electrode layer) 13, a positive electrode layer (third electrode layer) 14, a protecting member 18, and a positive electrode current collector 19.

Negative electrode layer 10 is formed in a plate shape, and negative electrode layer 10 includes an upper surface (first main surface) 20 and a lower surface (second main surface) 21. Negative electrode layer 10 includes a negative electrode collector plate 15, a negative electrode active material layer 16 formed on an upper surface of negative electrode collector plate 15, and a negative electrode active material layer 17 formed on a lower surface of negative electrode collector plate 15. Negative electrode collector plate 15 is formed to extend toward negative electrode terminal 6, and negative electrode collector plate 15 is connected to negative electrode terminal 6.

Solid electrolyte layer 11 is formed on upper surface 20, and solid electrolyte layer 12 is formed on lower surface 21.

Positive electrode layer 13 is formed opposite to negative electrode layer 10 relative to solid electrolyte layer 11, and positive electrode layer 13 is formed on an upper surface 22 of solid electrolyte layer 11.

Positive electrode layer 13 is formed at a position distant from an outer peripheral edge portion of upper surface 22. Therefore, an exposed portion 30 and an exposed portion 31 are formed on upper surface 22 of solid electrolyte layer 11. Exposed portion 30 is located on the positive electrode terminal 5 side, and exposed portion 31 is located on the negative electrode terminal 6 side.

Positive electrode layer 14 is formed opposite to negative electrode layer 10 relative to solid electrolyte layer 12, and positive electrode layer 14 is formed on a lower surface 23 of solid electrolyte layer 12.

Positive electrode layer 14 is formed at a position distant from an outer peripheral edge portion of lower surface 23. Therefore, an exposed portion 32 and an exposed portion 33 are formed on lower surface 23 of solid electrolyte layer 12. Exposed portion 32 is located on the positive electrode terminal 5 side, and exposed portion 33 is located on the negative electrode terminal 6 side.

Protecting member 18 includes an insulating layer (first insulating layer) 29 and an insulating layer 27. Insulating layer 29 is formed in exposed portion 30. Insulating layer 29 includes an insulating layer 25 and an insulating layer 26.

Insulating layer 25 is formed to extend from exposed portion 30 to the positive electrode terminal 5 side. On the positive electrode terminal 5 side, exposed portion 30 is formed to cover an outer peripheral edge portion of solid electrolyte layer 11.

Insulating layer 26 is formed on an upper surface of insulating layer 25. Insulating layer 26 is formed to extend from the upper surface of insulating layer 25 through a region above the outer peripheral edge portion of solid electrolyte layer 11 toward the positive electrode terminal 5 side.

Insulating layer 27 is formed in exposed portion 32. Insulating layer 27 is formed to extend from exposed portion 32 toward the positive electrode terminal 5 side. Insulating layer 27 is formed to cover an outer peripheral edge portion of solid electrolyte layer 12 located on the positive electrode terminal 5 side.

Positive electrode current collector 19 is provided on positive electrode layer 13 and extends to cover insulating layer 25 and insulating layer 26. Positive electrode current collector 19 is formed to extend toward positive electrode terminal 5. A tip of positive electrode current collector 19 is connected to positive electrode terminal 5.

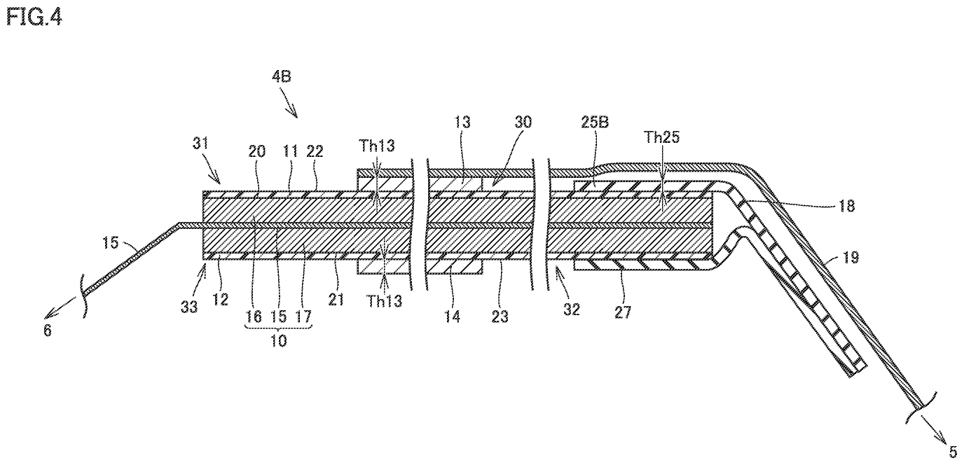

FIG. 4 is a cross-sectional view showing unit stacked body 4B. Unlike unit stacked body 4A, unit stacked body 4B does not include insulating layer 26. A configuration of unit stacked body 4B except for insulating layer 26 is substantially the same as that of unit stacked body 4A. Therefore, unit stacked body 4B includes an insulating layer (second insulating layer) 25B and insulating layer 27, and insulating layer 25B is the same as insulating layer 25 of unit stacked body 4A described above.

(First Inventive Point of Present Disclosure)

In FIG. 2, “number of layers N” represents the number of unit stacked bodies 4.

“Integer value M” represents an integer value obtained by rounding up all digits to the right of a decimal point of number of layers N/2×0.1. Here, each of unit stacked bodies 4 ranging from unit stacked body 4 located on an upper end surface (first end surface) of electrode assembly 2 to integer value M-th unit stacked body 4 corresponds to unit stacked body 4A shown in FIG. 3. That is, the number of unit stacked bodies 4A is equal to integer value M.

Each of unit stacked bodies 4 ranging from integer value M+1-th unit stacked body 4 from the upper end surface of electrode assembly 2 to unit stacked body 4 located on a lower end surface of electrode assembly 2 corresponds to unit stacked body 4B shown in FIG. 4. When “number of layers L” represents the number of unit stacked bodies 4B, a total of number of layers L and integer value M is number of layers N.

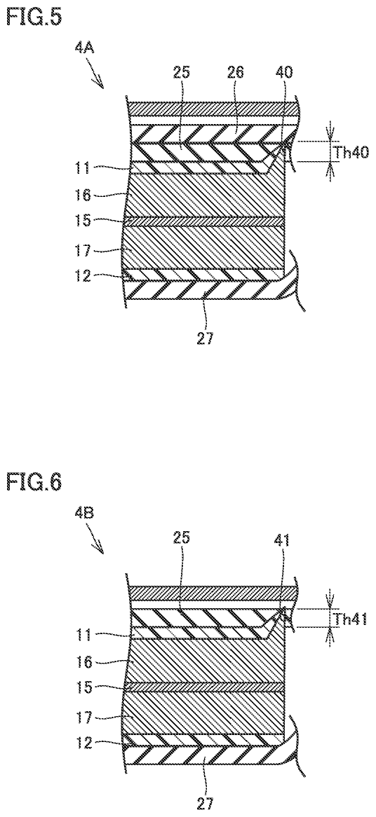

In a process of manufacturing unit stacked bodies 4A and 4B, burrs 40 and 41 may be formed in unit stacked bodies 4A and 4B as shown in FIGS. 5 and 6. In the present embodiment, burrs 40 and 41 are disposed to protrude toward the upper end surface of electrode assembly 2. A process of formation of burrs 40 and 41 will be described below.

In FIG. 5, burr 40 is formed to protrude upward from the outer peripheral edge portion of solid electrolyte layer 11 on the positive electrode terminal 5 side. Similarly, in FIG. 6, burr 41 is formed to protrude upward from the outer peripheral edge portion of solid electrolyte layer 11 on the positive electrode terminal 5 side.

A height Th40 represents a height of protrusion of burr 40 from upper surface 22 of solid electrolyte layer 11, and a height Th41 represents a height of protrusion of burr 41 from upper surface 22 of solid electrolyte layer 11. Heights Th40 and Th41 are variable in the manufacturing process. Each of heights Th40 and Th41 is, for example, equal to or less than 60 μm.

As shown in FIGS. 5 and 6, burrs 40 and 41 are formed such that a part of negative electrode active material layer 16 protrudes upward and solid electrolyte layer 12 covers a part of the protruding portion of negative electrode active material layer 16.

In FIG. 2, an internal pressure in laminate film 3 is approximately 40 Pa. Therefore, at least a part of laminate film 3 comes into close contact with electrode assembly 2 and the upper end surface of electrode assembly 2 is pressed by laminate film 3.

Therefore, unit stacked body 4A located on the upper end surface of electrode assembly 2 is pressed downward. As a result, when there is burr 40 shown in FIG. 5, burr 40 is pressed against insulating layer 25. Here, insulating layer 26 is formed on the upper surface of insulating layer 25 to suppress contact of burr 40 with positive electrode current collector 19. An overlapping portion of insulating layer 25 and insulating layer 26 is located on the outer peripheral edge portion of solid electrolyte layer 11 where burr 40 is formed.

If negative electrode active material layer 16 of burr 40 comes into contact with positive electrode current collector 19, a short circuit occurs in this portion, which results in a potential drop of solid-state battery 1.

In unit stacked body 4B shown in FIG. 6, the pressing force is transmitted through at least integer value M unit stacked bodies 4A to unit stacked body 4B. Therefore, the pressing force applied to unit stacked body 4B is smaller than the pressing force applied to unit stacked body 4A. A load at which burr 41 is pressed against insulating layer 25 of unit stacked body 4B is smaller than a load at which burr 40 is pressed against insulating layer 25 of unit stacked body 4A.

In unit stacked body 4B, penetration of burr 41 through insulating layer 25 to come into contact with positive electrode current collector 19 is suppressed.

That is, by setting the number of unit stacked bodies 4A at integer value M, the occurrence of an internal short circuit in solid-state battery 1 can be suppressed.

Integer value M is obtained by rounding up all digits to the right of a decimal point of a value determined from the following formula A. Number of layers N represents the number of unit stacked bodies 4.

Number of layers N/2×0.1 (formula A)

(Second Inventive Point of Present Disclosure)

In FIG. 3, “thickness Th13” represents a thickness of positive electrode layer 13.

“Thickness Th29” represents a thickness of insulating layer 29. Specifically, “thickness Th29” represents a thickness of the overlapping portion of insulating layer 25 and insulating layer 26, of insulating layer 29. In FIGS. 3 and 4, “thickness Th25” represents a thickness of each of insulating layers 25 and 25B. A thickness of insulating layer 27 is the same as the thickness of insulating layer 25.

Solid-state battery 1 according to the present embodiment satisfies a condition of the following formula B. In the formula B, “N1” represents the number of stacked positive electrode layers 13 and 14 (a total of the number of stacked positive electrode layers 13 and the number of stacked positive electrode layers 14). The number of stacked insulating layers 25 and 27 (a total of the number of stacked insulating layers 25 and the number of stacked insulating layers 27) is the same as the number of stacked positive electrode layers 13 and 14. A thickness of positive electrode layer 14 is the same as the thickness of positive electrode layer 13, and each of these thicknesses is represented by thickness Th13. The thickness of insulating layer 25 is the same as the thickness of insulating layer 27, and each of these thicknesses is represented by thickness Th25. “M1” represents the number of stacked insulating layers 29.

(Th13−Th25)×N1−((Th29−Th25)×M1)>0 (formula B)

When the formula B above is satisfied, a thickness of a portion of the electrode assembly passing through positive electrode layer 13 and positive electrode layer 14 is greater in stacking direction D than a thickness of a portion of the electrode assembly passing through insulating layer 25, insulating layer 27 and insulating layer 26. That is, when the formula B above is satisfied, the portion of the electrode assembly passing through insulating layer 25, insulating layer 27 and insulating layer 26 is provided with a gap in stacking direction D. Therefore, concentration of a load on the portion where insulating layer 26, insulating layer 25 and insulating layer 27 are stacked when the pressing force is applied to the upper end surface of electrode assembly 2 can be suppressed.

Thus, penetration of burr 40 through insulating layer 25 and insulating layer 26 to come into contact with positive electrode current collector 19 can be suppressed. As a result, a voltage drop of unit stacked body 4 can be suppressed.

As shown in the following formula C, thickness Th29 of the overlapping portion of insulating layer 25 and insulating layer 26 is greater than height Th40 of burr 40.

(Thickness Th29)/burr height Th40 (formula C)

In the formula C, in an electrode assembly that does not include unit stacked bodies 4A (electrode assembly composed only of unit stacked bodies 4B), thickness Th25 is used instead of thickness Th29.

Therefore, even when positive electrode current collector 19 is pressed downward by laminate film 3, penetration of burr 40 through the overlapping portion of insulating layer 25 and insulating layer 26 can be suppressed.

A constituent material of unit stacked body 4 configured as mentioned above will be described.

(Positive Electrode Current Collector 19)

In FIG. 3 and the like, positive electrode current collector 19 may have a thickness of, for example, 10 μm to 20 μm. Positive electrode current collector 19 may include, for example, metal foil and a carbon film (not shown). The metal foil may include, for example, at least one selected from the group consisting of Al, stainless steel, nickel (Ni), chromium (Cr), platinum (Pt), niobium (Nb), iron (Fe), titanium (Ti), and zinc (Zn). The metal foil may be, for example, Al foil or the like.

The carbon film covers a part of a surface of the metal foil. The carbon film may, for example, be disposed between the metal foil and positive electrode layer 13, and the carbon film may also be disposed between the metal foil and positive electrode layer 14. The carbon film includes a carbon material. The carbon material may include, for example, carbon black or the like (such as acetylene black). The carbon film may further include a binder and the like. The binder may include, for example, polyvinylidene fluoride (PVdF) or the like. The carbon film may be composed of, for example, 10% by mass to 20% by mass of the carbon material, and the binder that occupies the remainder. The carbon film may be composed of, for example, about 15% by mass of the carbon material, and about 85% by mass of the binder.

(Positive Electrode Layer)

Each of positive electrode layers 13 and 14 includes a positive electrode active material layer. Each of positive electrode layers 13 and 14 may have a thickness of, for example, 5 μm to 50 μm.

Each of positive electrode layers 13 and 14 may have a thickness of, for example, 0.1 μm to 1000 μm. Each of positive electrode layers 13 and 14 may have a thickness of, for example, 50 μm to 200 μm. Each of positive electrode layers 13 and 14 includes a positive electrode active material. Each of positive electrode layers 13 and 14 may further include, for example, a solid electrolyte, a conductive material, a binder and the like.

The positive electrode active material may be, for example, a powder material. The positive electrode active material may have a median size of, for example, 1 μm to 30 μm. The median size refers to a particle size in volume-based particle size distribution at which the cumulative particle volume accumulated from the small particle size side reaches 50% of the total particle volume. The median size may be measured using a laser diffraction type particle size distribution measurement device. The positive electrode active material may have a median size of, for example, 5 μm to 15 μm.

The positive electrode active material may include an arbitrary component. The positive electrode active material may include, for example, at least one selected from the group consisting of lithium cobalt oxide, lithium nickel oxide, lithium manganese oxide, nickel cobalt lithium manganese oxide (such as LiNi_{1/3}Co_{1/3}Mn_{1/3}O₂), nickel cobalt lithium aluminate, and lithium iron phosphate. The positive electrode active material may be subjected to surface treatment. A buffer layer may be formed on a surface of the positive electrode active material by surface treatment. The buffer layer may include, for example, lithium niobate (LiNbO₃) or the like. The buffer layer may inhibit formation of a lithium depletion layer. Thus, a reduction in battery resistance is expected.

The solid electrolyte may be, for example, a powder material. The solid electrolyte may have a median size of, for example, 0.1 μm to 10 μm. The solid electrolyte may have a median size of, for example, 1 μm to 5 μm.

The solid electrolyte has ion conductivity. The solid electrolyte does not substantially have electron conductivity. The solid electrolyte may include, for example, a sulfide solid electrolyte or the like. The solid electrolyte may include, for example, an oxide solid electrolyte or the like. A blending amount of the solid electrolyte may be, for example, 1 parts by mass to 200 parts by mass with respect to 100 parts by mass of the positive electrode active material.

The sulfide solid electrolyte may be in a glass state. The sulfide solid electrolyte may form glass ceramics (also referred to as “crystallized glass”). The sulfide solid electrolyte may include an arbitrary component as long as the sulfide solid electrolyte includes sulfur (S). The sulfide solid electrolyte may include, for example, lithium phosphorus sulfide or the like.

Lithium phosphorus sulfide may be expressed by, for example, the following formula (I):

Li₂ₓP₂₋₂ₓS₅₋₄ₓ (0.5≤x≤1) (I).

Lithium phosphorus sulfide may have a composition of, for example, Li₃PS₄, Li₇P₃S₁₁ or the like.

The sulfide solid electrolyte may be synthesized using a mechanochemical method. A composition of the sulfide solid electrolyte may be expressed by, for example, a mixing ratio of raw materials. For example, “75Li₂S-25P₂S₅” indicates that an amount-of-substance fraction of “Li₂S” with respect to the entire raw materials is 0.75 and an amount-of-substance fraction of “P₂S₅” with respect to the entire raw materials is 0.25. The sulfide solid electrolyte may include, for example, at least one selected from the group consisting of 50Li₂S-50P₂S₅, 60Li₂S-40P₂S₅, 70Li₂S-30P₂S₅, 75Li₂S-25P₂S₅, 80Li₂S-20P₂S₅, and 90Li₂S-10P₂S₅.

For example, “Li₂S—P₂S₅” indicates that a mixing ratio of “Li₂S” and “P₂S₅” is arbitrary. The sulfide solid electrolyte may include, for example, lithium halide or the like. The sulfide solid electrolyte may include, for example, at least one selected from the group consisting of Li₂S—P₂S₅, Li₂S—SiS₂, LiI—Li₂S—SiS₂, LiI—Si2_{S}—P₂S₅, LiI—LiBr—Li₂S—P₂S₅, LiI—Li₂S—P₂S₅, LiI—Li₂O—Li₂S—P₂S₅, LiI—Li₂S—P₂O₅, LiI—Li₃PO₄—P₂S₅, and Li₂S—P₂S₅—GeS₂.

The oxide solid electrolyte may include an arbitrary component as long as the oxide solid electrolyte includes oxygen (O). The oxide solid electrolyte may include, for example, at least one selected from the group consisting of lithium phosphate oxynitride (LIPON), lithium zinc germanate (LISICON), lithium lanthanum zirconium oxide (LLZO), and lithium lanthanum titanium oxide (LLTO).

The conductive material has electron conductivity. The conductive material may include an arbitrary component. The conductive material may include, for example, at least one selected from the group consisting of carbon black (such as acetylene black), vapor-grown carbon fiber (VGCF), carbon nanotube (CNT), and graphene flake. A blending amount of the conductive material may be, for example, 0.1 parts by mass to 10 parts by mass with respect to 100 parts by mass of the positive electrode active material.

The binder combines solid-state materials. The binder may include an arbitrary component. The binder may include, for example, a fluororesin or the like. The binder may include, for example, at least one selected from the group consisting of PVdF and vinylidene fluoride-hexafluoropropylene copolymer (PVdF-HFP). A blending amount of the binder may be, for example, 0.1 parts by mass to 10 parts by mass with respect to 100 parts by mass of the positive electrode active material.

(Negative Electrode Collector Plate 15)

Negative electrode collector plate 15 may have a thickness of, for example, 5 μm to 50 μm. Negative electrode collector plate 15 may have a thickness of, for example, 5 μm to 15 μm. Negative electrode collector plate 15 may include, for example, metal foil or the like. The metal foil may include, for example, at least one selected from the group consisting of stainless, copper (Cu), Ni, Fe, Ti, cobalt (Co), and Zn. The metal foil may be, for example, Ni foil, Ni-plated Cu foil, Cu foil or the like.

(Negative Electrode Active Material Layers 16 and 17)

Each of negative electrode active material layers 16 and 17 may have a thickness of, for example, 0.1 μm to 1000 μm. Each of negative electrode active material layers 16 and 17 may have a thickness of, for example, 50 μm to 200 μm. Each of negative electrode active material layers 16 and 17 includes a negative electrode active material. Each of negative electrode active material layers 16 and 17 may further include, for example, a solid electrolyte, a conductive material, a binder and the like.

The negative electrode active material may be, for example, a powder material. The negative electrode active material may have a median size of, for example, 1 μm to 30 μm. The negative electrode active material may have a median size of, for example, 1 μm to 10 μm.

The negative electrode active material may include an arbitrary component. The negative electrode active material may include, for example, at least one selected from the group consisting of lithium titanate (Li₄Ti₅O₁₂), graphite, soft carbon, hard carbon, silicon, silicon oxide, silicon-based alloy, tin, tin oxide, and tin-based alloy.

Details of the solid electrolyte are as described above. The solid electrolyte included in each of negative electrode active material layers 16 and 17 may have the same composition as that of the solid electrolyte included in each of positive electrode layers 13 and 14. The solid electrolyte included in each of negative electrode active material layers 16 and 17 may have a composition different from that of the solid electrolyte included in each of positive electrode layers 13 and 14. A blending amount of the solid electrolyte may be, for example, 1 parts by mass to 200 parts by mass with respect to 100 parts by mass of the negative electrode active material.

Details of the conductive material are as described above. The conductive material included in each of negative electrode active material layers 16 and 17 may have the same composition as that of the conductive material included in each of positive electrode layers 13 and 14. The conductive material included in each of negative electrode active material layers 16 and 17 may have a composition different from that of the conductive material included in each of positive electrode layers 13 and 14. A blending amount of the conductive material may be, for example, 0.1 parts by mass to 10 parts by mass with respect to 100 parts by mass of the negative electrode active material.

Details of the binder are as described above. The binder included in each of negative electrode active material layers 16 and 17 may have the same composition as that of the binder included in each of positive electrode layers 13 and 14. The binder included in each of negative electrode active material layers 16 and 17 may have a composition different from that of the binder included in each of positive electrode layers 13 and 14. A blending amount of the binder may be, for example, 0.1 parts by mass to 10 parts by mass with respect to 100 parts by mass of the negative electrode active material.

(Solid Electrolyte Layer)

Each of solid electrolyte layers 11 and 12 may have a thickness of, for example, 0.1 μm to 1000 μm. Each of solid electrolyte layers 11 and 12 may have a thickness of, for example, 0.1 μm to 300 μm. Solid electrolyte layers 11 and 12 are interposed between positive electrode layers 13 and 14 and negative electrode layer 10 (negative electrode active material layers 16 and 17), respectively. Each of solid electrolyte layers 11 and 12 is a so-called separator. Solid electrolyte layers 11 and 12 physically separate positive electrode layers 13 and 14 from negative electrode layer 10, respectively. Solid electrolyte layers 11 and 12 spatially separate positive electrode layers 13 and 14 from negative electrode layer 10, respectively. Solid electrolyte layers 11 and 12 cut off electron conduction between positive electrode layers 13 and 14 and negative electrode layer 10, respectively.

Each of solid electrolyte layers 11 and 12 includes a solid electrolyte. Solid electrolyte layers 11 and 12 form ion conduction paths between positive electrode layers 13 and 14 and negative electrode layer 10, respectively. Each of solid electrolyte layers 11 and 12 may further include, for example, a binder and the like.

Details of the solid electrolyte are as described above. The solid electrolyte included in each of solid electrolyte layers 11 and 12 may have the same composition as that of the solid electrolyte included in each of positive electrode layers 13 and 14. The solid electrolyte included in each of solid electrolyte layers 11 and 12 may have a composition different from that of the solid electrolyte included in each of positive electrode layers 13 and 14. The solid electrolyte included in each of solid electrolyte layers 11 and 12 may have the same composition as that of the solid electrolyte included in each of negative electrode active material layers 16 and 17. The solid electrolyte included in each of solid electrolyte layers 11 and 12 may have a composition different from that of the solid electrolyte included in each of negative electrode active material layers 16 and 17.

The binder may include an arbitrary component. The binder may include, for example, at least one selected from the group consisting of PVdF-HFP, butyl rubber (IIR) and butadiene rubber (BR).

(Insulating Layers 25, 26 and 27)

A thickness of each of insulating layers 25, 26 and 27 is equal to or more than 10 μm and equal to or less than 50 μm. The thickness of each of insulating layers 25, 26 and 27 may be equal to or more than 20 μm and equal to or less than 40 μm. The thickness of each of insulating layers 25, 26 and 27 is, for example, 30 μm. Each of insulating layers 25, 26 and 27 includes a resin layer made of PET (Polyethyleneterephthalate) or the like, and an adhesive layer.

In FIG. 3, the thickness of the overlapping portion of insulating layer 25 and insulating layer 26 is equal to or more than 10 μm and equal to or less than 100 μm. The thickness of the overlapping portion may be equal to or more than 40 μm and equal to or less than 80 μm, and the thickness of the overlapping portion is, for example, 60 μm.

(Manufacturing Method)

A method for manufacturing solid-state battery 1 will be described.

The method for manufacturing solid-state battery 1 includes a step of forming electrode assembly 2, and a step of sealing electrode assembly 2 in laminate film 3. The step of forming electrode assembly 2 includes a step of forming unit stacked bodies 4A and 4B, and a step of stacking unit stacked bodies 4A and 4B.

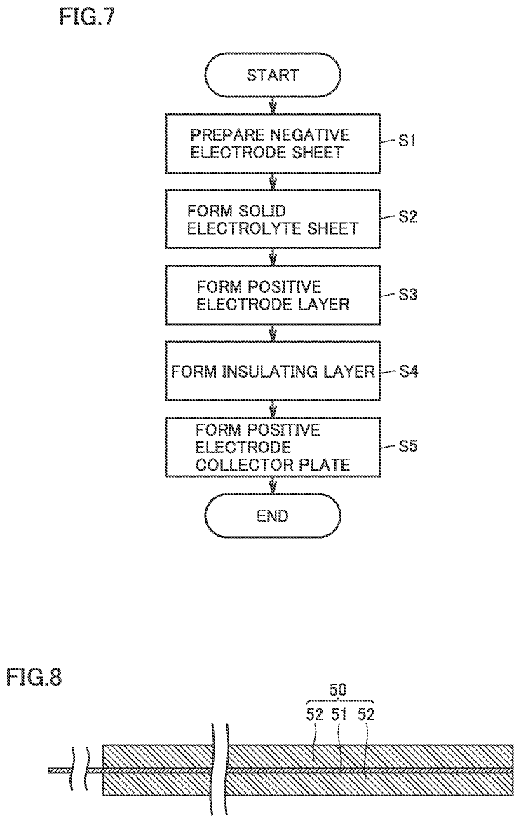

The step of forming unit stacked body 4A will be described. FIG. 7 is a manufacturing flow chart showing the step of forming unit stacked body 4A. The step of forming unit stacked body 4A includes a step of preparing a negative electrode sheet (S1), a step of forming a solid electrolyte sheet on the negative electrode sheet (S2), a step of forming a positive electrode layer on the solid electrolyte sheet (S3), a step of forming an insulating layer (S4), and a step of forming a positive electrode collector plate (S5).

FIG. 8 is a cross-sectional view showing a step of preparing a negative electrode sheet 50. The step of forming negative electrode sheet 50 includes a step of preparing Ni collector foil 51, a step of applying slurry to front and rear surfaces of Ni collector foil 51, and a step of drying the applied slurry to form a negative electrode composite material layer 52.

The slurry is formed, for example, by weighing predetermined amounts of lithium titanate (Li₄Ti₅O₁₂), a sulfide solid electrolyte, PVdF, and a conductive material (VGCF), and dispersing these in butyl butyrate using an ultrasonic homogenizer.

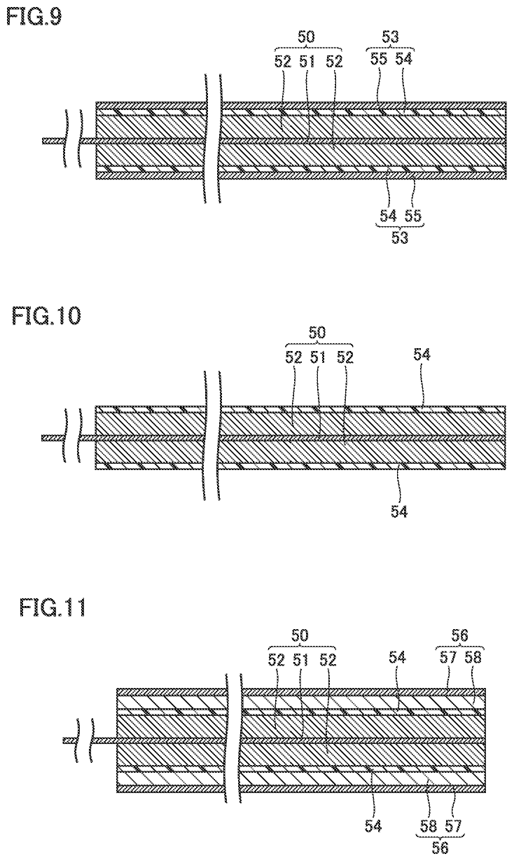

FIG. 9 is a cross-sectional view showing a step of forming a sheet 53 on negative electrode sheet 50. The step shown in FIG. 9 includes a step of forming sheet 53, and a step of bonding sheet 53 to negative electrode sheet 50.

The step of forming sheet 53 includes a step of preparing aluminum foil 55, a step of applying slurry to one main surface of aluminum foil 55, and a step of drying the slurry to form a solid electrolyte layer 54.

The slurry is formed, for example, by weighing predetermined amounts of a sulfide solid electrolyte, PVdF (polyvinylidene fluoride resin) and a conductive material (VGCF), and dispersing these in butyl butyrate using an ultrasonic homogenizer.

The slurry formed as described above is formed on one main surface of aluminum foil 55, and then, the slurry is dried, to thereby form solid electrolyte layer 54 on aluminum foil 55.

Then, two sheets 53 are formed, and one sheet 53 is bonded to negative electrode composite material layer 52 on the upper surface side, and the other sheet 53 is bonded to negative electrode composite material layer 52 on the lower surface side.

FIG. 10 is a cross-sectional view showing a step after the step shown in FIG. 9. The step shown in FIG. 10 corresponds to a step of removing aluminum foil 55. As a result, solid electrolyte layer 54 is exposed to the outside.

FIG. 11 shows a step of forming a positive electrode sheet 56 on a surface of each solid electrolyte layer 54. The step of forming positive electrode sheet 56 includes a step of preparing collector foil 57 made of aluminum or the like, a step of forming slurry on one main surface of collector foil 57, and a step of drying the slurry to form a positive electrode composite material layer 58.

The slurry is formed by weighing predetermined amounts of a positive electrode active material (LiNbO₃ coat, LiNi_{1/3}Co_{1/3}O₂), a sulfide solid electrolyte (Li₃PS₄), PVdF, and a conductive material (VGCF), and dispersing these in butyl butyrate using an ultrasonic homogenizer.

The slurry formed on collector foil 57 is dried, to thereby form positive electrode composite material layer 58 on one main surface of collector foil 57. Then, positive electrode sheet 56 is disposed such that positive electrode composite material layer 58 of positive electrode sheet 56 is in contact with solid electrolyte layer 54.

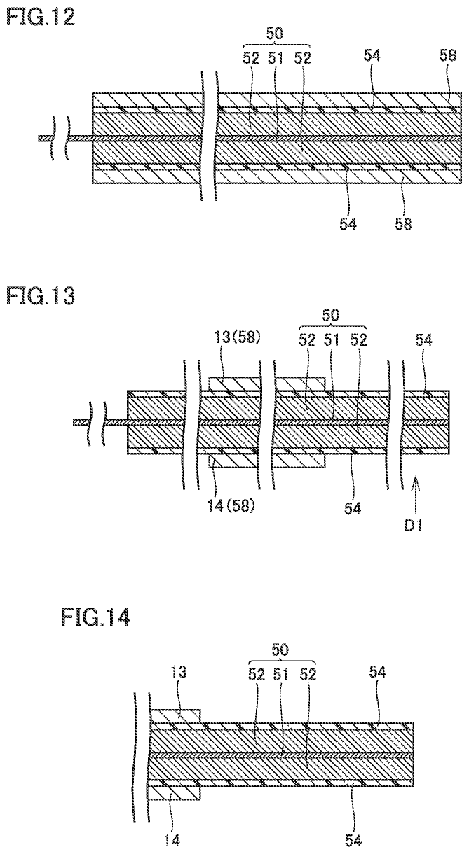

FIG. 12 is a cross-sectional view showing a step after the step shown in FIG. 11. The step shown in FIG. 12 corresponds to a step of removing collector foil 57. As a result of this step, positive electrode composite material layer 58 is exposed to the outside.

Then, a stacked body composed of negative electrode sheet 50, solid electrolyte layer 54 and positive electrode composite material layer 58 is subjected to press working.

As a result of press working, positive electrode composite material layer 58 has a thickness of 35 μm, solid electrolyte layer 54 has a thickness of 30 μm, and negative electrode sheet 50 has a thickness of 65 μm.

FIG. 13 shows a step of removing a part of positive electrode composite material layer 58. The step shown in FIG. 13 corresponds to a step of removing an outer peripheral edge of each positive electrode composite material layer 58 by irradiating the outer peripheral edge of each positive electrode composite material layer 58 with laser light and the like. For example, a portion of each positive electrode composite material layer 58 located between the outer peripheral edge of positive electrode composite material layer 58 and a portion located on the inner side of the outer peripheral edge portion by approximately 3 mm is removed. The outer peripheral edge portion of each positive electrode composite material layer 58 is removed as described above, to thereby form positive electrode layers 13 and 14.

FIG. 14 is a cross-sectional view showing a step of cutting a part of the stacked body shown in FIG. 13. In this step, portions located on the inner side of the outer peripheral edge portion of negative electrode sheet 50 and solid electrolyte layer 54 by approximately 2 mm are cut. Negative electrode sheet 50 and each solid electrolyte layer 54 are cut as described above, to thereby form negative electrode layer 10 and solid electrolyte layers 11 and 12. In the step shown in FIG. 14, burr 40 shown in FIG. 5 may be formed.

For example, when the laser light is applied from a direction D1 shown in FIG. 13, burr 40 (burr 41) is formed at the outer peripheral edge portion on the negative electrode active material layer 16 side as shown in FIG. 5. For example, when the laser light is applied from the lower surface side toward the upper surface of the stacked body, burr 40 (burr 41) is formed on the upper surface of the stacked body.

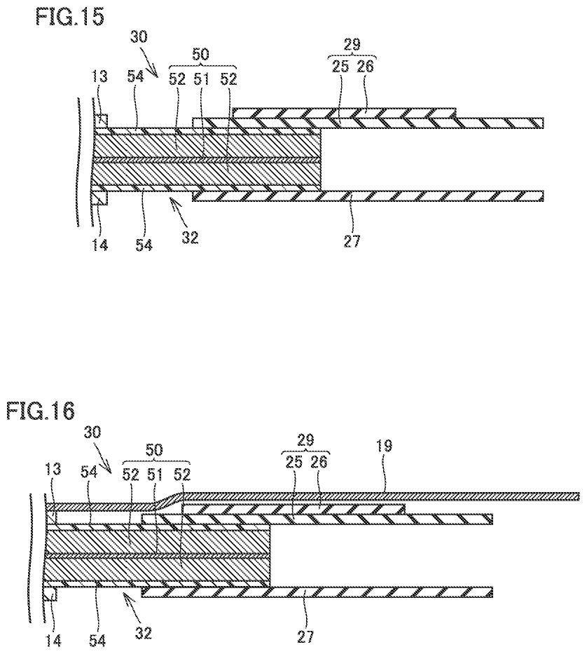

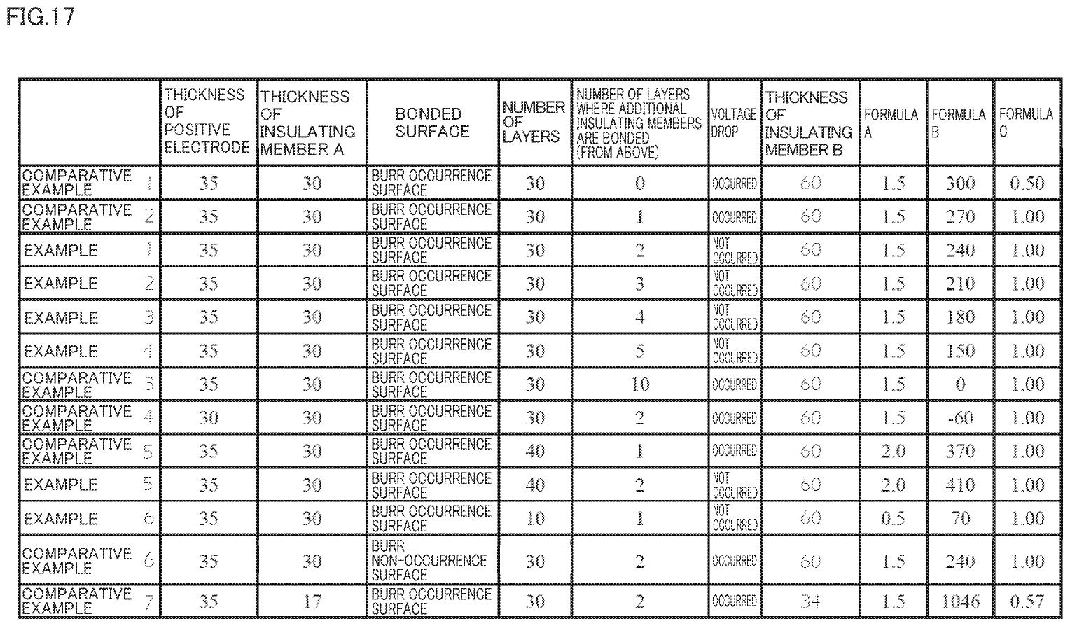

FIG. 15 is a cross-sectional view showing a step of bonding insulating layers 25, 26 and 27. Insulating layers 25 and 26 are disposed on the side where burr 40 is formed. Specifically, insulating layer 25 is bonded to exposed portion 30, and insulating layer 26 is bonded to the upper surface of insulating layer 25. Insulating layer 27 is bonded to exposed portion 32.

FIG. 16 is a cross-sectional view showing a step of disposing positive electrode current collector 19. Positive electrode current collector 19 is disposed on an upper surface of positive electrode layer 13.

Then, negative electrode collector plate 15, positive electrode current collector 19 and insulating layers 25, 26 and 27 are bended as shown in FIG. 3 and the like. Unit stacked body 4A can thus be formed.

Although the step of forming unit stacked body 4A has been described, unit stacked body 4B can also be formed similarly. As for unit stacked body 4B, insulating layer 26 is not disposed in the step shown in FIG. 15. Then, positive electrode current collector 19 is disposed on the upper surface of positive electrode layer 13, and thereafter, negative electrode collector plate 15, positive electrode current collector 19 and insulating layers 25 and 27 are bended as shown in FIG. 4. Unit stacked body 4B can thus be formed.

Then, L unit stacked bodies 4B are stacked, and thereafter, M unit stacked bodies 4A are stacked, to thereby form electrode assembly 2.

Then, in the atmosphere of 40 Pa, electrode assembly 2 is inserted into laminate film 3 to seal laminate film 3. Solid-state battery 1 can thus be manufactured.

### EXAMPLES

Next, solid-state batteries according to Examples and solid-state batteries according to Comparative Examples will be described.

FIG. 17 is a table showing the results of studies about solid-state batteries according to Examples 1 to 6 and solid-state batteries according to Comparative Examples 1 to 7.

In the table shown in FIG. 17, “thickness of positive electrode” refers to thickness Th13 shown in FIG. 3. “Thickness of insulating member A” refers to thickness Th25. “Insulating member A” refers to insulating layer 25 and insulating layer 27. “Bonded surface” refers to a surface where insulating layer 25 or insulating layer 29 is provided. “Burr occurrence surface” refers to a surface where burr 40 or 41 is formed. In FIG. 3, “burr occurrence surface” refers to upper surface 22, and specifically to exposed portion 30 of upper surface 22. “Burr non-occurrence surface” refers to a surface where no burr is formed. In the example shown in FIG. 3, “burr non-occurrence surface” refers to lower surface 23, and specifically to exposed portion 32.

“Number of layers” refers to number of layers N shown in FIG. 2. “Number of layers where additional insulating members are bonded” refers to integer value M of unit stacked bodies 4A shown in FIG. 2. As for “voltage drop”, each of the solid-state batteries according to Examples 1 to 6 and the solid-state batteries according to Comparative Examples 1 to 7 was charged to 2.3 V and left at 25° C. for 24 hours, and then, a voltage of each solid-state battery was measured and a solid-state battery exhibiting a voltage drop of 10 mV or more was determined as a solid-state battery dropped in voltage. “Thickness of insulating member B” refers to thickness Th29, and “insulating member B” refers to insulating layer 29. “Formula A”, “formula B” and “formula C” shown in the table refer to formula A, formula B and formula C described above, respectively.

### Comparative Example 1

The solid-state battery according to Comparative Example 1 is formed by stacking thirty unit stacked bodies 4B shown in FIG. 4 to thereby form an electrode assembly, and sealing the electrode assembly in a laminate film in an atmosphere in which a pressure is 40 Pa.

A unit stacked body having burr 41 shown in FIG. 6 is selected as each unit stacked body 4B. Specifically, a unit stacked body including burr 41 having height Th41 of 60 μm is selected using a laser microscope in the step shown in FIG. 14. Thickness Th25 of each of insulating layer 25 and insulating layer 27 is 30 μm.

Thickness Th13 of each of positive electrode layers 13 and 14 is 35 μm, a thickness of each of solid electrolyte layer 11 and solid electrolyte layer 12 is 30 μm, and a thickness of negative electrode layer 10 is 65 μm.

In the step shown in FIG. 13, a portion of 3 mm from the outer peripheral edge portion of positive electrode composite material layer 58 is removed. In FIG. 14, portions located on the inner side of the outer peripheral edge portion of negative electrode sheet 50 and solid electrolyte layer 54 by approximately 2 mm are cut.

### Comparative Example 2

An electrode assembly of the solid-state battery according to Comparative Example 2 is formed by stacking twenty-nine unit stacked bodies 4B shown in FIG. 4 and one unit stacked body 4A. Each unit stacked body 4B is formed similarly to each unit stacked body 4B in Comparative Example 1 described above.

Unit stacked body 4A is disposed on an uppermost surface of the electrode assembly. Thickness Th29 of unit stacked body 4A is 60 μm. Burr 40 is also formed in unit stacked body 4A and height Th40 of burr 40 is 60 μm. In Comparative Example 2 as well, the electrode assembly is sealed in a laminate film, similarly to Comparative Example 1.

### Example 1

An electrode assembly of the solid-state battery according to Example 1 is formed by stacking twenty-eight unit stacked bodies 4B and two unit stacked bodies 4A. Specifically, as shown in FIG. 2, two unit stacked bodies 4A are disposed on the upper surface side of the electrode assembly.

Each unit stacked body 4B is formed similarly to each unit stacked body 4B in Comparative Examples 1 and 2, and each unit stacked body 4A is formed similarly to unit stacked body 4A in Comparative Example 2. In Example 1 as well, the electrode assembly is sealed in a laminate film, similarly to Comparative Examples 1 and 2.

### Example 2

An electrode assembly of the solid-state battery according to Example 2 is formed by stacking twenty-seven unit stacked bodies 4B and three unit stacked bodies 4A. Three unit stacked bodies 4A are disposed on the upper surface side of the electrode assembly, and unit stacked bodies 4B are stacked on the lower surface side of these three unit stacked bodies 4A.

Each unit stacked body 4B is formed similarly to those in Comparative Examples 1 and 2, and each unit stacked body 4A is formed similarly to that in Comparative Example 2. In Example 2 as well, the electrode assembly is sealed in a laminate film, similarly to Comparative Examples 1 and 2.

### Example 3

An electrode assembly of the solid-state battery according to Example 3 is formed by stacking twenty-six unit stacked bodies 4B and four unit stacked bodies 4A. Four unit stacked bodies 4A are disposed on the upper surface side of the electrode assembly, and unit stacked bodies 4B are stacked on the lower surface side of these four unit stacked bodies 4A.

Each unit stacked body 4B is formed similarly to each unit stacked body 4B in Comparative Examples 1 and 2, and each unit stacked body 4A is formed similarly to unit stacked body 4A in Comparative Example 2. In Example 2 as well, the electrode assembly is sealed in a laminate film, similarly to Comparative Examples 1 and 2.

### Example 4

An electrode assembly of the solid-state battery according to Example 4 is formed by stacking twenty-five unit stacked bodies 4B and five unit stacked bodies 4A. Five unit stacked bodies 4A are disposed on the upper surface side of the electrode assembly, and unit stacked bodies 4B are stacked on the lower surface side of these five unit stacked bodies 4A.

Each unit stacked body 4B is formed similarly to each unit stacked body 4B in Comparative Examples 1 and 2, and each unit stacked body 4A is formed similarly to unit stacked body 4A in Comparative Example 2. In Example 4 as well, the electrode assembly is sealed in a laminate film, similarly to Comparative Examples 1 and 2.

### Comparative Example 3

An electrode assembly of the solid-state battery according to Comparative Example 3 is formed by stacking twenty unit stacked bodies 4B and ten unit stacked bodies 4A. Ten unit stacked bodies 4A are disposed on the upper surface side of the electrode assembly, and unit stacked bodies 4B are stacked on the lower surface side of these ten unit stacked bodies 4A.

Each unit stacked body 4B is formed similarly to each unit stacked body 4B in Comparative Examples 1 and 2, and each unit stacked body 4A is formed similarly to unit stacked body 4A in Comparative Example 2. In Comparative Example 3 as well, the electrode assembly is sealed in a laminate film, similarly to Comparative Examples 1 and 2.

### Comparative Example 4

An electrode assembly of the solid-state battery according to Comparative Example 4 is formed by stacking twenty-eight unit stacked bodies 4B and two unit stacked bodies 4A. Two unit stacked bodies 4A are disposed on the upper surface side of the electrode assembly, and unit stacked bodies 4B are stacked on the lower surface side of these two unit stacked bodies 4A.

In Comparative Example 4, each of unit stacked bodies 4A and 4B is formed such that each of positive electrode layers 13 and 14 has a thickness of 30 μm. Except for the thickness of each of positive electrode layers 13 and 14, each unit stacked body 4B is formed similarly to each unit stacked body 4B in Comparative Examples 1 and 2, and each unit stacked body 4A is formed similarly to unit stacked body 4A in Comparative Example 2. In Comparative Example 4 as well, the electrode assembly is sealed in a laminate film, similarly to Comparative Examples 1 and 2.

### Comparative Example 5

An electrode assembly of the solid-state battery according to Comparative Example 5 is formed by stacking thirty-nine unit stacked bodies 4B shown in FIG. 4 and one unit stacked body 4A. Each unit stacked body 4B is formed similarly to each unit stacked body 4B in Comparative Example 1 described above. Unit stacked body 4A is disposed on the uppermost surface of the electrode assembly. In Comparative Example 5 as well, the electrode assembly is sealed in a laminate film, similarly to Comparative Example 1.

### Example 5

An electrode assembly of the solid-state battery according to Example 5 is formed by stacking thirty-eight unit stacked bodies 4B shown in FIG. 4 and two unit stacked bodies 4A. Two unit stacked bodies 4A are disposed on the upper surface side of the electrode assembly. Each unit stacked body 4B is formed similarly to each unit stacked body 4B in Comparative Examples 1 and 2, and each unit stacked body 4A is formed similarly to unit stacked body 4A in Comparative Example 2.

In Example 5 as well, the electrode assembly is sealed in a laminate film, similarly to Comparative Example 1.

### Example 6

An electrode assembly of the solid-state battery according to Example 6 is formed by stacking ten unit stacked bodies 4B and one unit stacked body 4A. One unit stacked body 4A is disposed on an upper surface of the electrode assembly. Each unit stacked body 4B is formed similarly to each unit stacked body 4B in Comparative Examples 1 and 2, and unit stacked body 4A is formed similarly to unit stacked body 4A in Comparative Example 2.

In Example 6 as well, the electrode assembly is sealed in a laminate film, similarly to Comparative Example 1.

### Comparative Example 6

An electrode assembly of the solid-state battery according to Comparative Example 6 is formed by stacking twenty-eight unit stacked bodies 4B and two unit stacked bodies 4C. Unit stacked bodies 4C are disposed on the upper end surface side of the electrode assembly.

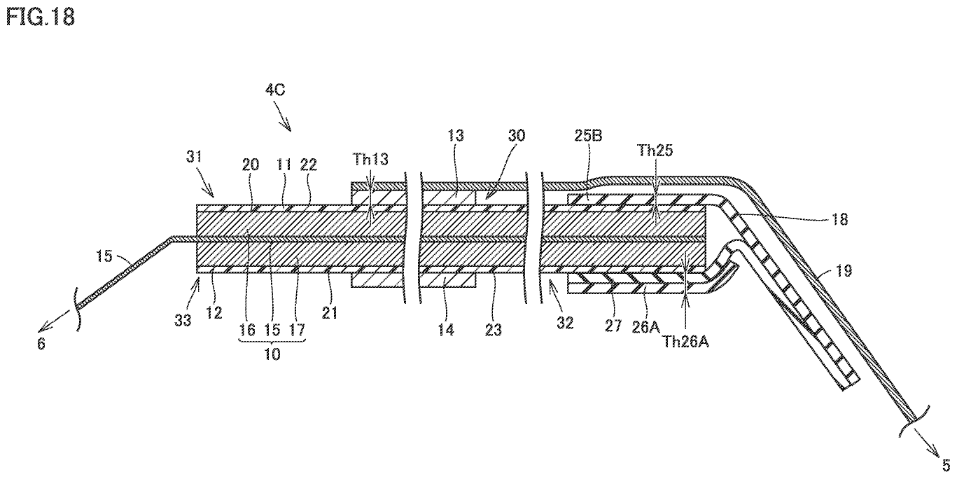

FIG. 18 is a cross-sectional view showing unit stacked body 4C. Unit stacked body 4C includes an insulating layer 26A disposed on a lower surface of insulating layer 27. Unit stacked body 4C is not provided with insulating layer 26. A thickness Th26A of an overlapping portion of insulating layer 26A and insulating layer 27 is 60 μm.

The remaining configuration of unit stacked body 4C other than the above-described configuration is similar to that of unit stacked body 4A. Similarly to unit stacked body 4A, burr 40 is also formed in unit stacked body 4C. Each unit stacked body 4B in Comparative Example 6 is formed similarly to each unit stacked body 4B in Comparative Examples 1 and 2.

### Comparative Example 7

An electrode assembly of the solid-state battery according to Comparative Example 7 is formed by stacking twenty-eight unit stacked bodies 4B and two unit stacked bodies 4A. Two unit stacked bodies 4A are disposed on the upper surface side of the electrode assembly.

In each unit stacked body 4B in Comparative Example 7, thickness Th25 of insulating layer 25 shown in FIG. 4 is 17 μm. In each unit stacked body 4A in Comparative Example 7, thickness Th29 shown in FIG. 3 is 34 μm. The remaining configuration of each unit stacked body 4B other than the above-described configuration is similar to that of each unit stacked body 4B in Comparative Examples 1 and 2.

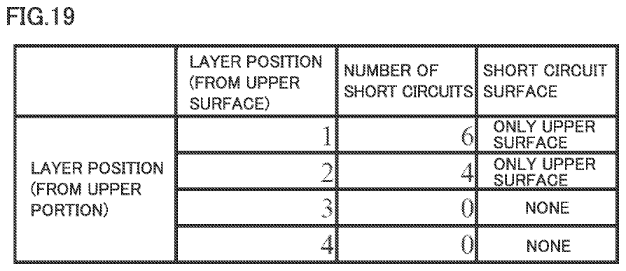

FIG. 19 is a table showing the results of short circuit analysis about ten disassembled electrode assemblies of the solid-state battery according to Comparative Example 1 in which a voltage drop occurred. In the table shown in FIG. 19, “layer position” refers to a position of a unit stacked body where a short circuit occurred. Specifically, “layer position” refers to the number of layers counted from the upper surface of the solid-state battery. “Number of short circuits” refers to the number of electrode assemblies where a short circuit occurred. Specifically, the layer position of “1” and the number of short circuits of “6” indicate the number of electrode assemblies where a short circuit occurred in the unit stacked body having the layer position of “1”, of the ten electrode assemblies. “Only upper surface” of “short circuit surface” indicates that a short circuit occurred on the upper surface 22 side of the unit stacked body. “None” of “short circuit surface” indicates that a short circuit did not occur in both upper surface 22 and lower surface 23.

In FIG. 19, it can be seen that a short circuit occurs in up to two layers of the upper layer portion of the electrode assembly. It can be seen that a short circuit surface occurs in the upper surface of each unit stacked body 4B.

According to the analysis results shown in FIG. 19, it can be seen that a pressure (atmospheric pressure or restraint pressure) applied to the electrode assembly is applied to unit stacked bodies 4A in up to two layers from the upper end of the electrode assembly. It can be seen that a large pressure is not applied to unit stacked bodies 4B in third and subsequent layers. This may be because the applied pressure is counteracted by reaction force of unit stacked body 4B in each layer and thus the applied pressure is less likely to reach unit stacked bodies 4B in third and subsequent layers.

In FIG. 17, the solid-state batteries according to Comparative Examples 1 and 2 and the solid-state batteries according to Examples 1 to 4 are compared. As a result, it can be seen that a voltage drop occurs in the solid-state battery in which one layer of the upper portion of the electrode assembly is composed of unit stacked body 4A and the second and subsequent layers are composed of unit stacked bodies 4B. On the other hand, in the solid-state battery in which the second to fifth layers from the upper portion of the electrode assembly are composed of unit stacked bodies 4A, a voltage drop does not occur, and thus, it can be determined that an internal short circuit does not occur.

In any of the solid-state batteries according to Comparative Examples 1 and 2 and the solid-state batteries according to Examples 1 to 4, number of layers N is “30” and the value of formula A is “1.5”. Integer value M obtained by rounding up all digits to the right of the decimal point of the value calculated from formula A is “2”.

The number of layers of unit stacked bodies 4A in Comparative Example 1 is “0”, which is smaller than “2”. The number of layers of unit stacked bodies 4A in Comparative Example 2 is “1”, which is smaller than “2”.

The number of layers of unit stacked bodies 4A in Example 1 is “2”, the number of layers of unit stacked bodies 4A in Example 2 is “3”, the number of layers of unit stacked bodies 4A in Example 3 is “4”, and the number of layers of unit stacked bodies 4A in Example 4 is “5”. In Examples 1 to 4, the number of layers of unit stacked bodies 4A is equal to or larger than “2”.

As described above, it can be seen that the occurrence of an internal short circuit can be suppressed by setting number of layers M of unit stacked bodies 4A from the upper end of the electrode assembly at integer value M or more obtained by rounding up all digits to the right of a decimal point of formula A, when number of layers N is “30”.

The number of layers in the solid-state battery according to Comparative Example 5 and the number of layers in the solid-state battery according to Example 5 are both “40”. Formula A in each of Comparative Example 5 and Example 5 is “2.0”. Since the digit to the right of the decimal point of the value of formula A is “0”, the integer value obtained by rounding up all digits to the right of the decimal point of formula A is “2”. The number of layers of unit stacked bodies 4A in Comparative Example 5 is “1”, and the number of layers of unit stacked bodies 4A in Example 5 is “2”. As described above, in Example 5, the number of layers is equal to or larger than integer value M obtained by rounding up all digits to the right of the decimal point of formula A, and in Comparative Example 5, the number of layers is smaller than integer value M. In the solid-state battery according to Example 5, a voltage drop does not occur, and in the solid-state battery according to Comparative Example 5, a voltage drop occurs.

In Example 6, number of layers N is “10”. The value of formula A is “0.5”, and the integer value obtained by rounding up all digits to the right of the decimal point is “1”. The number of layers of unit stacked bodies 4A is “1”. In Example 6 as well, the number of layers of unit stacked bodies 4A is equal to or larger than the integer value obtained by rounding up all digits to the right of the decimal point of the value of formula A.

As described above, it can be seen that in the solid-state batteries having various numbers of layers N as well, the occurrence of a voltage drop can be suppressed when the number of layers of unit stacked bodies 4A from the upper end surface is equal to or larger than the integer value obtained by rounding up all digits to the right of the decimal point of the value of formula A.

When a value of formula B becomes equal to or smaller than “0”, the portion of the electrode assembly where insulating layers 25, 26 and 27 are located becomes thick. Therefore, when a pressure is applied to the electrode assembly, a load is likely to concentrate on the portion where insulating layers 25, 26 and 27 are located. As a result, an internal short circuit can be expected to occur, which may cause a voltage drop of the solid-state battery.

In the electrode assembly in Comparative Example 3, the value calculated from formula B is “0”, which is equal to or smaller than “0”. In the solid-state battery according to Comparative Example 3, a voltage drop occurs.

On the other hand, number of layers N of each of the electrode assemblies in Examples 1 to 4 is “30”, which is the same as number of layers N of the electrode assembly in Comparative Example 3. In each of the electrode assemblies in Examples 1 to 4, the value calculated from formula B is equal to or larger than “0”. In the solid-state batteries according to Examples 1 to 4, a voltage drop does not occur.

In the electrode assembly in Comparative Example 7, a value calculated from formula C is “0.57”, which is smaller than “1”. In the solid-state battery according to Comparative Example 7, a voltage drop occurs.

The electrode assembly in Comparative Example 1 is composed entirely of unit stacked bodies 4B. Therefore, a value of thickness Th25 is used as “thickness Th29 of insulating member B” in formula C described above. In the electrode assembly in Comparative Example 1, the value calculated from formula C is “0.50”, which is smaller than “1”. In the solid-state battery according to Comparative Example 1, a voltage drop occurs.

On the other hand, in each of the electrode assemblies in Examples 1 to 4, the value calculated from formula C is “1”, which is equal to or larger than “1”. In the solid-state batteries according to Examples 1 to 4, a voltage drop does not occur.

Although the embodiments of the present disclosure have been described, it should be understood that the embodiments disclosed herein are illustrative and non-restrictive in every respect. The technical scope of the present disclosure is defined by the terms of the claims and is intended to include any modifications within the scope and meaning equivalent to the terms of the claims.

What is claimed is:

1. A solid-state battery comprising:
an electrode assembly including a plurality of unit stacked bodies arranged in a stacking direction; and
a laminate film that seals the electrode assembly, wherein
the electrode assembly includes a first end surface located on one end in the stacking direction, and a second end surface located on the other end in the stacking direction,
each of the plurality of unit stacked bodies includes:
a first electrode layer including a first main surface and a second main surface;
a first solid electrolyte layer formed on the first main surface;
a second solid electrolyte layer formed on the second main surface;
a second electrode layer and an insulating layer formed opposite to the first electrode layer relative to the first solid electrolyte layer;
a collector plate formed opposite to the first solid electrolyte layer relative to the second electrode layer and the insulating layer; and
a third electrode layer formed opposite to the first electrode layer relative to the second solid electrolyte layer,
the insulating layer is formed to cover an outer peripheral edge portion of the first solid electrolyte layer,
the collector plate is provided on the second electrode layer and provided to cover the insulating layer,
when N represents the number of the unit stacked bodies, and M represents an integer value obtained by rounding up all digits to the right of a decimal point of N/2×0.1,
first unit stacked bodies refer to unit stacked bodies ranging from a unit stacked body located on the first end surface to at least an M-th unit stacked body, of the plurality of unit stacked bodies, and
second unit stacked bodies refer to unit stacked bodies other than the first unit stacked bodies, of the plurality of unit stacked bodies, and
when the insulating layer provided in each of the first unit stacked bodies is defined as a first insulating layer and the insulating layer provided in each of the second unit stacked bodies is defined as a second insulating layer, a thickness of the first insulating layer is greater than a thickness of the second insulating layer.

2. The solid-state battery according to claim 1, wherein
a thickness of a portion of the electrode assembly passing through the second electrode layer and the third electrode layer is greater, in the stacking direction, than a thickness of a portion of the electrode assembly passing through the insulating layer.

3. The solid-state battery according to claim 1, wherein
a burr is formed at the outer peripheral edge portion of each of the first unit stacked bodies, and
the first insulating layer is disposed to cover the burr.

4. The solid-state battery according to claim 3, wherein
the thickness of the first insulating layer is greater than a height of the burr.
